(19) United States
(12) Patent Application Publication
(10) Pub. No.: US 2005/0015298 A1
(43) Pub. Date: Jan. 20, 2005

(54) eCommerce tuition crediting

(75) Inventor: Peter J. Cipriani, Broadview Heights, OH (US)

Correspondence Address: Jay F. Moldovanyi;Fay, Sharpe, Fagan, Minnich & McKee, LLP, 7th Floor, 1100 Superior Avenue, Cleveland, OH, 44114-2518, US

(73) Assignee: OneCause LLC

(21) Appl. No.: 10/619,887

(22) Filed: Jul. 15, 2003

(51) Int. Cl. G06F 17/60

(52) U.S. Cl. 705/14

(57) ABSTRACT

In a tuition assistance program, a website 10 solicits schools 12 to join the program through a marketing campaign 14. Upon acceptance, a school administrator sets up a school portal on the website 10 that represents the school 12. The school 12 invites families 16 to participate in the program. The families each go to the website, obtain a family ID, and solicit supporters 18. The supporters 18 go to the family's portal to associate themselves with the family 16. The supporters shop in on-line retail outlets that are affiliates of the website 10. A portion of each purchase that the supporter 18 makes is credited to the tuition of a student of the family 16 who attends the school 12.

### BACKGROUND OF THE DISCLOSURE

The present invention relates to the electronic business or eBusiness arts. Particularly, it deals with using eCommerce as a medium for tuition crediting and will be described with particular reference thereto. However it is to be understood that the present invention is also applicable to other areas of commission crediting and is not limited to the aforementioned tuition crediting use of electronic commerce.

In recent years, the Internet has become a convenient medium through which many aspects of business are conducted. In the year 2003 over $100 billion will be spent in the United States on retail merchandise purchased over the Internet. Internet retail holds advantages for all parties involved. For the retailer, the Internet provides a widely available, low-overhead forum in which to advertise and sell. For the consumer, it provides the convenience of shopping from one's own home.

Internet retailers find that, all else being equal, profit margins are 5% to 15% higher for Internet sales than for conventional sales. Retailers can use this added revenue for advertising of their product. Such advertising over the Internet may come in many varieties, such as pop-up windows, advertisements from Internet service providers, incentives, and others.

With particular reference to incentive type advertisements, the retailer provides some sort of incentive to the consumer for choosing their product over another product. One such incentive includes commissions, that is, a percentage of the product price, given to certain organizations. A consumer who favors an organization might be more inclined to purchase a product if a percentage of the purchase price is going to fund an organization of their choice.

Each year the cost of living increases and along with it, the price of private schooling. Middle income families who desire a high quality education for their children may find it difficult to afford private schooling, (which can range from grade school to college) needing to take out loans or seek other financial assistance.

The present invention provides a new and improved method that overcomes the above referenced problems and others.

### BRIEF DESCRIPTION OF THE INVENTION

Thus, in accordance with one aspect of the present invention, a method of conducting a business transaction over the Internet is provided. A product is offered for sale over the Internet and purchased. Some of the funds are forwarded to a institution. Credit is applied to accounts of enrollees enrolled at the institution.

In accordance with another aspect of the present invention, a method of enabling a business transaction is provided. A consumer is provided with access to an on-line retail agency, the consumer being associated with a student of an educational institution. Funds are exchanged, and a portion of the funds are received from the retail agency. At least a portion of the funds are credited to the account of a student.

In accordance with another aspect of the present invention, a method of providing tuition reimbursement for a school is provided. The school associates with a website that provides access for consumers to on-line vendors. Families are encouraged to participate in a profit sharing program. Funds are received from the website when supporters of the families make purchases from the vendors. Some of the funds are credited to the accounts of students associated with the consumers.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 is a flowchart illustrating basic steps of a tuition crediting process.

FIG. 2 is a flowchart illustrating supporter access to an on-line vendor and subsequent tuition reimbursement.

### DETAILED DESCRIPTION OF THE PREFERRED EMBODIMENT

Referring now to the drawings wherein the FIGURES are for purposes of illustrating a preferred embodiment of the invention only and not for purposes of limiting same, a tuition crediting system is disclosed.

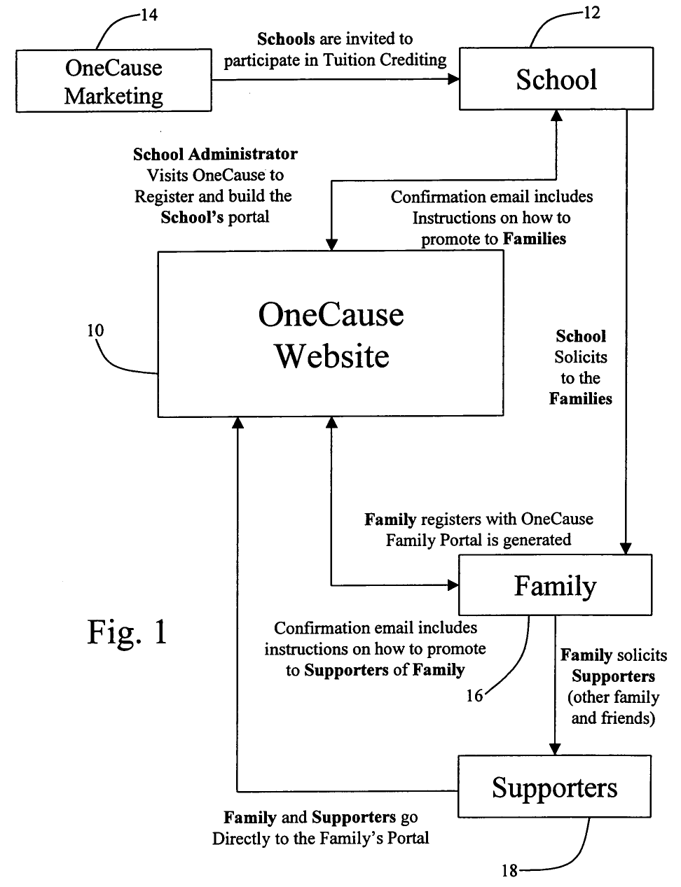

In the preferred embodiment, with reference to FIG. 1, a proprietary website 10, run by a manager (termed OneCause herein) initiates recruitment of schools 12 or educational institutions, ranging from pre-kindergarten and day care facilities and grade schools to colleges, to participate in the tuition crediting program. It is to be understood, however, that any institution that serves individuals can be benefitted by the present invention. Through a marketing campaign 14, schools 12 receive an invitation to join the tuition crediting program. The invitation directs the school 12 to the website 10, and includes brief instructions for setting up a school account. A school representative, that is, a school administrator, enters a special user ID and password, as instructed by the invitation.

This action takes the school administrator to an administration sheet, where the administrator submits his name, the address of the school, and other information. Upon completion of registration, the administrator is presented with a page including options for his account. Typically, an account administrator does not have more than one account to maintain, but in some instances, it might be necessary for the same administrator to administer to a plurality of accounts and the administrator status can be upgraded to include control of multiple accounts.

When a school representative responds to the website 10 in the affirmative, he will be given instructions on how to build a portal for his specific school 12. The administrator is forwarded to a build portal form. The portal that the administrator builds is similar to all other portals on the website 10 with the exception that it is easily identified as being associated with the school of the administrator. Once the administrator completes the portal for his school 12, then he receives an e-mail confirmation with attachments outlining a process for inviting families 16 of students of the school 12 to participate in the tuition crediting program.

From the administrator, families 16 receive invitations for joining the tuition crediting program. The families 16 are directed to the school's portal. They are then forwarded to a family registration page. In the process of setting up the family page, the family 16 needs to input a school ID number, as given by the school administrator, to associate the family 16 with their school 12. Upon completion of the log in page, the family 16 is assigned a unique URL family portal. Additionally, the family 16 receives a confirmation e-mail from the website instructing the family how to contact supporters 18. Supporters 18 are typically friends and extended family of the family 16, who find gratification in the support of the student of the family 16.

Solicitations from the family 16 contain instructions to the supporters 18 on how to access the family's portal. Supporters 18 go to the family's portal 10 when they wish to purchase products or services via the Internet. This associates the activities of the supporter 18 with the family 16 identified by the entered family ID. The supporter 18 can then access retailers' websites that have an agreement with the website 10. A preset percentage of the price of each item or service purchased by the supporter 18 on the website 10, from any retailer listed on the website, is given to the website 10. The website 10 then gives that sum, minus administrative expenses and the like, to the school 12 in the name of the family 16 with whom the supporter 18 is associated. The school 12 applies the funds towards the tuition of the student of the family 16. Thus, the supporter 18 purchases merchandise for personal use, and reduces the financial burden of the family 16 in paying for the education of a child at the school in the process. It is to be understood that the supporter 18 can choose between a plurality of families 16, for instance choosing one family code for a certain purchase, and another for additional purchases. In an example of a grandparent with multiple children, each child having their own families, the grandparent might want to spread purchases out over the families of their children.

The supporter 18 has a choice to patronize any of a plurality of retailers, all of which have individual agreements as to the extent of commission that will be paid to the website 10, the commissions being posted adjacent the retailer's site link. Supporters 18 also have the opportunity to e-mail a friend. Preferably, the website 10 sends an e-mail to the indicated friend with a link to the family portal of the family 16 with which the supporter 18 was associated when she initiated the e-mail.

The school is provided with a reporting mechanism which allows them to credit the participating families in a batch manner. The report will tightly integrate with all tuition management services and most tuition management software programs generally available.

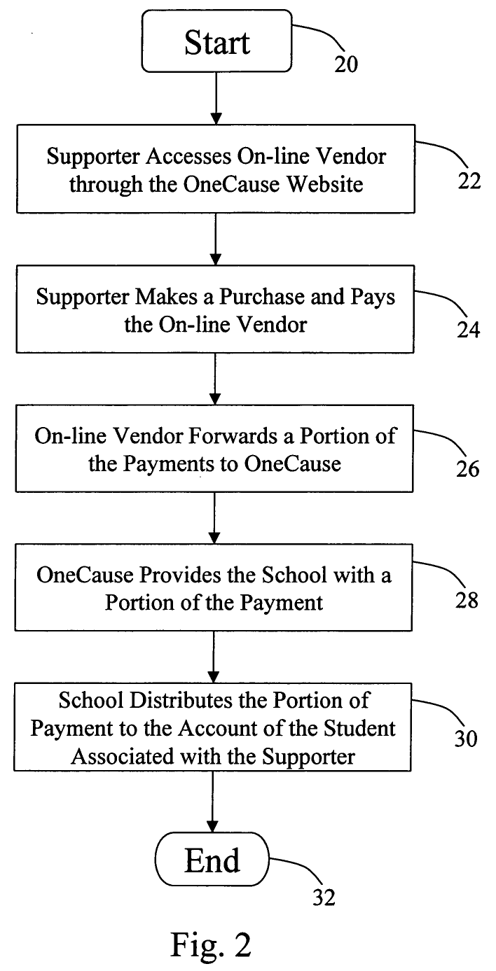

With reference to FIG. 2, after the school portal has been established and families have solicited supporters, a supporter starts a transaction 20 by accessing the Internet in a well known fashion. The supporter accesses an on-line vendor through the OneCause website 22, and directions are provided to the supporter on how to associate with the family whom they support. The supporter makes a purchase from the on-line vendor and pays the vendor 24. As per a pre-determined agreement, the vendor forwards a portion of the payment to OneCause 26. OneCause then provides the school whose portal was accessed by the supporter with a portion of the payment 28. The school then credits the account of the family with whom the supporter is associated with a portion of the payment 30. After the family's account is credited, the current transaction ends 32.

While FIG. 2 describes an individual transaction, it is to be understood that each payment from OneCause to the school need not be on an individual basis. OneCause can make one or more bulk payments to the school (e.g. quarterly, annually, etc.) concurrently with a transaction synopsis to facilitate distribution to multiple students' accounts at one time.

Thus, in accordance with one aspect of the present invention, a method of conducting a business transaction is provided. A product or service is provided in exchange for financial compensation over the Internet. A percentage of the financial compensation is provided to a third party learning institution. The portion of the financial compensation is applied to a tuition of a student of the learning institution.

In accordance with another aspect of the present invention, a method of enabling a business transaction is provided. A consumer is provided with access to an on-line retail agency, the consumer being associated with a student of an educational institution. A percentage of funds from the business transaction is received from the retail agency. A tuition account of the student is credited with a percentage of the funds provided by the retail agency.

The invention has been described with reference to a preferred embodiment. Modifications and alterations will occur to others upon a reading and understanding of the preceding detailed description. It is intended that the invention be construed as including all such modifications and alterations insofar as they come within the scope of the appended claims or the equivalents thereof.

1. A method of conducting a business transaction over the Internet, comprising:
offering one of a product and a service for sale over the Internet;
purchasing said one of a product and a service for financial compensation;
forwarding a portion of said financial compensation to a third-party institution; and,
applying financial credit in the amount of said portion of said financial compensation to an account of at least one enrollee enrolled in the third party institution.

2. The method as set forth in claim 1, further including:
recruiting customers by subscribing to a profit sharing service provider.

3. The method as set forth in claim 2, wherein the recruiting step includes the profit sharing service provider conducting a marketing campaign.

4. The method as set forth in claim 3, wherein the marketing campaign seeks to acquire school participation.

5. The method as set forth in claim 4, wherein the recruiting step further includes the step of school administrators setting up accounts for students at their institutions, thereby allowing supporters of students of participant schools to purchase said one of a product and a service over the Internet.

6. A method of enabling a four-way business transaction between a consumer, a merchant, a manager, and an educational institution comprising:
a manager providing a consumer with access to an on-line merchant, the consumer being associated with a student of an educational institution;
the consumer conducting a business transaction with the on-line merchant wherein funds are transferred from the consumer to the on-line merchant;
the manager receiving from the merchant a portion of the funds transferred by the consumer in the business transaction with the merchant;
the manager crediting at least a percentage of the portion of funds received by the manager to the account of the student of the educational institution.

7. The method as set forth in claim 6, wherein the step of providing a consumer with access to an on-line retail agency includes the step of initiating recruitment for consumers.

8. The method as set forth in claim 7, wherein the recruitment includes a marketing campaign by the manager directed to prospective educational institution participants.

9. The method as set forth in claim 7, wherein the step of providing includes allowing the manager to set up an educational institution account with which consumers associated with a student of the educational institution can associate.

10. The method as set forth in claim 6, further including:
building an Internet portal for access of the consumer.

11. The method as set forth in claim 6, further including:
the manager providing a summary report to the educational institution that reflects activity by consumers associated with the educational institution.

12. A method of providing tuition reimbursement for a school comprising:
associating with a website that provides access for consumers to online providers of at least one of services and products;
encouraging families with students at the school to participate in a profit sharing program;
receiving funds from the website when consumers associated with students at the school make purchases from the on-line providers associated with the website;
crediting funds received from the website to the accounts of students of the school associated with the consumers that made purchases from the on-line providers.

13. The method as set forth in claim 12, wherein the step of associating includes responding to a marketing campaign initiated by the website.

14. The method as set forth in claim 12, wherein the step of associating includes a school administrator setting up an account of the website.

15. The method as set forth in claim 12, further including:
constructing a website portal for the school.

16. The method as set forth in claim 12, further including:
inviting families of students of the school to participate in a profit sharing program.

17. The method as set forth in claim 16, wherein the family participation includes encouraging friends to purchase from the online providers via the school's association with the website.

18. The method as set forth in claim 12, further including:
receiving a report from the website that facilitates fund disbursement among students who participated in the profit sharing program.
